(19) United States
(12) Patent Application Publication
(10) Pub. No.: US 2010/0033877 A1
(43) Pub. Date: Feb. 11, 2010

(54) ALIGNING DEVICE, ALIGNING METHOD, AND COMPUTER PRODUCT

(75) Inventor: Mitsuhiro Izumi, Yokohama (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/483,848

(22) Filed: Jun. 12, 2009

(30) Foreign Application Priority Data
Aug. 5, 2008 (JP) 2008-202186

(51) Int. Cl. G11B 5/48

(52) U.S. Cl. 360/245.9; G9B/5.147

(57) ABSTRACT

An aligning device includes a recognizing unit and a determining unit. The recognizing unit recognizes an intersection formed by two straight lines not parallel to each other among a plurality of straight lines of a register mark. The determining unit determines a position based on the recognized intersection. The register mark is used when an FPC terminal and a head terminal are superposed and connected. The FPC terminal is a wiring pattern formed on an FPC in a magnetic disk device. The head terminal is one of wiring patterns that are connected to a magnetic head in the magnetic disk device and is located in a portion that is superposed with the FPC terminal. The determining unit determines a position on the FPC where the head terminal is superposed.

### CROSS-REFERENCE TO RELATED APPLICATION(S)

This application is based upon and claims the benefit of priority of the prior Japanese Patent Application No. 2008-202186, filed on Aug. 5, 2008, the entire contents of which are incorporated herein by reference.

### FIELD

The embodiment discussed herein is directed to an aligning device, an aligning method, and a computer product.

### BACKGROUND

Generally, to connect a head terminal mounted on a carriage and an flexible printed circuit (FPC) terminal in a magnetic disk device, the fabricating device determines their connecting position by using a circular register mark. As illustrated in FIG. 13, the register mark is formed on both sides of a portion where an FPC terminal is formed. The FPC terminal refers to a portion that is connected to the head terminal in a wiring pattern formed on an FPC. FIG. 13 is a diagram for explaining a conventional technology.

Technologies for cooling a component in a hard disk have been disclosed as an example of those regarding the magnetic disk device. Such conventional technologies are disclosed in, for example, Japanese Laid-open Patent Publication No. 11-110960 (pp. 1-3, FIG. 1) and Japanese Laid-open Patent Publication No. 2000-156068 (pp. 1-3, FIG. 1).

With the conventional technologies, when the shape of the register mark changes, a position cannot be determined.

For example, when an FPC terminal is formed on an FPC, a large misalignment may occur, and the position of the register mark on both sides of the FPC terminal may also be significantly misaligned. As a result, the whole register mark cannot be formed on the FPC, the shape of the register mark is distorted from a circle, and thus the fabricating device cannot recognize it as a register mark.

### SUMMARY

According to an aspect of an embodiment, an aligning device includes a recognizing unit and a determining unit. The recognizing unit recognizes an intersection formed by two straight lines not parallel to each other among a plurality of straight lines included in a register mark. The determining unit determines a position based on the recognized intersection.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWING (S)

FIG. 1 is a diagram for explaining the general outline of an aligning device according to an embodiment of the invention;

FIG. 2 is a block diagram of the aligning device according to the embodiment;

FIG. 3 is a diagram for explaining a positional relation between a head terminal and an FPC terminal in the embodiment;

FIG. 4 is a diagram for explaining a positional relation between a register mark and the FPC terminal in the embodiment;

FIG. 5 is a diagram for explaining an intersection recognizing unit in the embodiment;

FIG. 6 is a diagram for explaining a difference in light reflectance between the presence and absence of a cover film in the embodiment;

FIG. 7 is a diagram for explaining exposure of an adjacent wiring pattern when the cover film is absent in the embodiment;

FIG. 8 is a diagram for explaining distortion of the shape of the register mark due to misalignment;

FIG. 9 is a diagram for explaining intersection recognition when a register mark is rectangular;

FIG. 10 is a flowchart of the operation of the aligning device in the embodiment;

FIG. 11 is a diagram for explaining intersection recognition when a register mark is triangular;

FIG. 12 is a diagram for explaining a program that implements the aligning device according to the embodiment; and

FIG. 13 is a diagram for explaining a conventional technology.

### DESCRIPTION OF EMBODIMENT(S)

Exemplary embodiments of the invention will be explained with reference to the accompanying drawings.

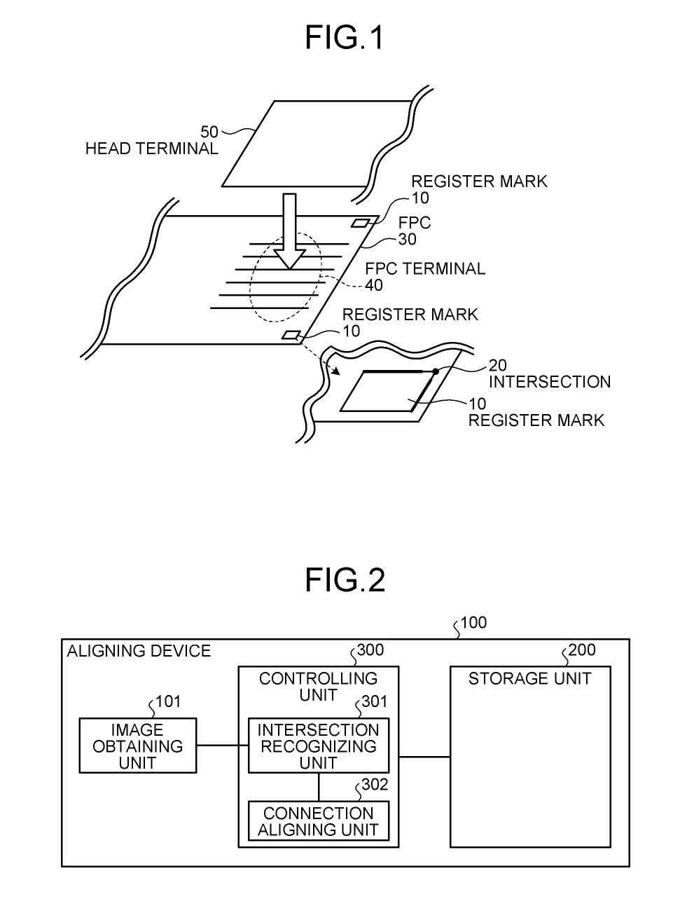

First, the general outline of the aligning device according to an embodiment is explained with reference to FIG. 1. FIG. 1 is a diagram for explaining the general outline of the aligning device according to the embodiment.

As illustrated in FIG. 1, the aligning device according to the embodiment recognizes an intersection 20 formed by two straight lines not parallel to each other from among a plurality of straight lines included in a register mark 10, and then uses the recognized intersection 20 to determine a position. For example, the register mark 10 is used when an FPC terminal 40 formed on an FPC 30 and a head terminal 50 are superposed for connection. The aligning device determines a position on the FPC 30 at which the head terminal 50 is superposed. Bold lines in FIG. 1 represent straight lines to be recognized by the aligning device.

That is, for example, if the register mark 10 for use in connecting the head terminal 50 and the FPC terminal 40 is in a polygonal shape, the aligning device of the embodiment determines a connecting position by using an intersection of lines extended from two sides of the polygon. Thus, the aligning device can stably perform alignment as long as it can recognize two sides even if part of the register mark is lost.

Next, the configuration of an aligning device 100 is described with reference to FIG. 2. FIG. 2 is a block diagram of the aligning device 100 according to the embodiment. As illustrated in FIG. 2, the aligning device 100 includes an image obtaining unit 101, a storage unit 200, and a controlling unit 300.

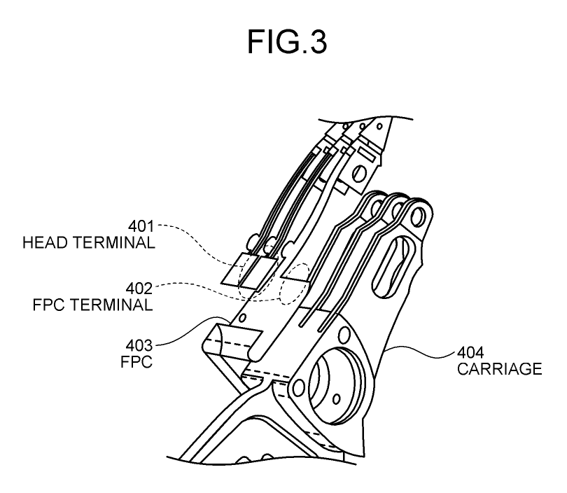

As illustrated in FIG. 3, the aligning device 100 connects a head terminal 401 and an FPC terminal 402 inside a magnetic disk device and, specifically, superposes the head terminal 401 on the FPC terminal 402 for connection. FIG. 3 is a diagram for explaining a positional relation between the head terminal and the FPC terminal in the embodiment.

The FPC terminal 402 is a portion that is connected to the head terminal 401 in a wiring pattern formed on an FPC 403. The head terminal 401 is a wiring pattern formed on a terminal portion on a side opposite to the magnetic head among wiring patterns for transferring information that is read and written by the magnetic head, and is connected to the FPC terminal 402. A carriage 404 illustrated in FIG. 3 is a component inside the magnetic disk device having a magnetic head.

Referring back to FIG. 2, the image obtaining unit 101 is connected to an intersection recognizing unit 301, described later, and may be a camera that captures an image. For example, under the control of the intersection recognizing unit 301, the image obtaining unit 101 obtains an image containing a register mark 500 and the FPC terminal 402, and sends the obtained image to the intersection recognizing unit 301. The image obtaining unit 101 may obtain an image from another device, and then send the image to the intersection recognizing unit 301. The storage unit 200 is connected to the controlling unit 300, and stores data for use in various aligning processes by the controlling unit 300.

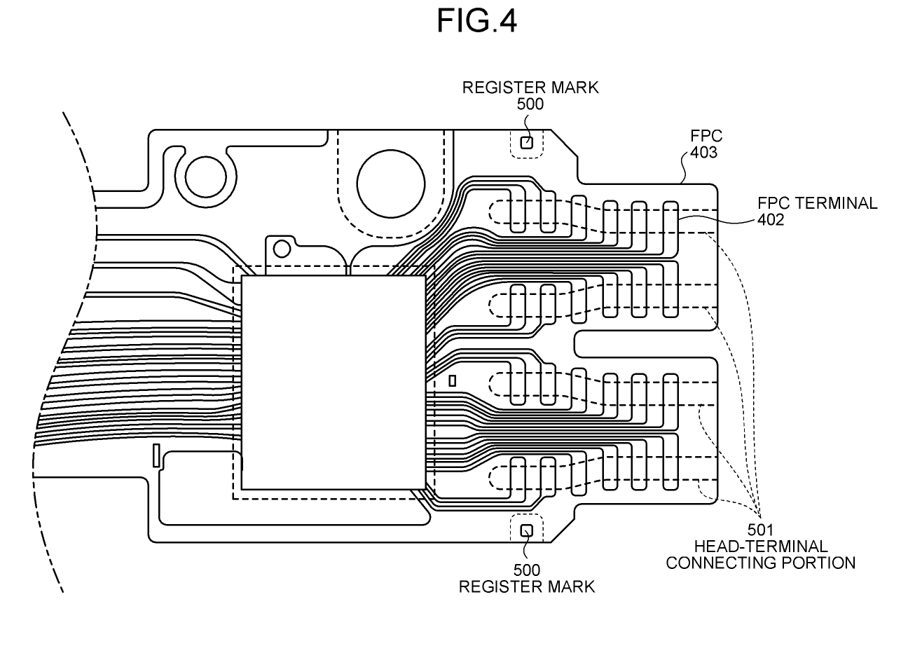

The register mark 500 is a mark for alignment used by the intersection recognizing unit 301 and, as illustrated in FIG. 4, is formed on both side of a portion on the FPC 403 where the FPC terminal 402 is formed. FIG. 4 is a diagram for explaining a positional relation between the register mark and the FPC terminal in the embodiment.

The register mark 500 refers to a pattern having a plurality of straight lines, and may be, for example, a triangular or rectangular pattern, or polygonal pattern with corners equal to or more than five. The register mark 500 is formed as, for example, a wiring pattern made of copper on the FPC 403. In the embodiment, the register mark 500 is described for example as being rectangular, i.e., in a quadrangle shape.

The register mark 500 is formed on both sides of a portion where the FPC terminal 402 is formed so that the register mark 500 can be recognized when the head terminal 401 is superposed onto the FPC terminal 402. That is, in the example of FIG. 4, the head terminal 401 is connected to a head-terminal connecting portion 501 represented by dotted lines, and the head terminal 401 is superposed on the FPC 403. To prevent the register mark 500 from being hidden by the head terminal 401 when the head terminal 401 is superposed thereon, the register mark 500 is formed on both side of the portion where the FPC terminal 402 is formed, i.e., the portion where the head terminal 401 to be superposed.

Referring back to FIG. 2, the controlling unit 300 is connected to the storage unit 200 and the image obtaining unit 101, has an internal memory for storing programs that define various aligning procedures, and performs various aligning processes with the programs. The controlling unit 300 includes the intersection recognizing unit 301 and the connection aligning unit 302.

The intersection recognizing unit 301 is connected to the image obtaining unit 101, and receives, for example, at connection timing, an image containing the register mark 500 and the FPC terminal 402 from the image obtaining unit 101. That is, the intersection recognizing unit 301 controls the image obtaining unit 101 to obtain an image containing the register mark 500 and the FPC terminal 402. The connection timing refers to, for example, timing when an instruction for alignment is received from a connecting device that connects the head terminal 401 and the FPC terminal 402.

The intersection recognizing unit 301 recognizes a plurality of straight lines not parallel to each other from the register mark 500 in the image received from the image obtaining unit 101, thereby recognizing an intersection 600 formed by the plurality of straight lines.

That is, the intersection recognizing unit 301 recognizes the intersection 600 formed by two straight lines not parallel to each other among straight lines included in the register mark 500 for use in superposing the head terminal 401 on the FPC terminal 402 for connection.

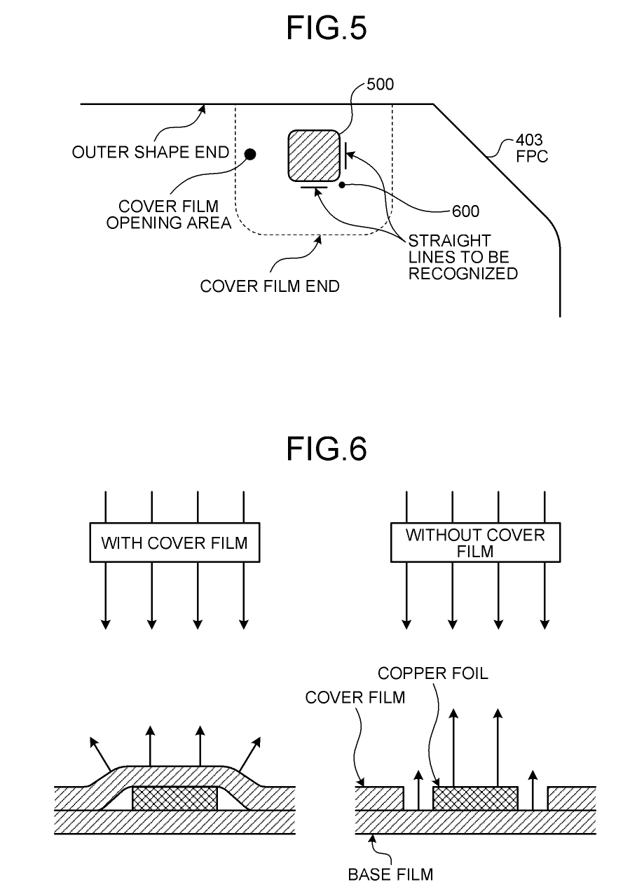

Described below is how to recognize an intersection when the register mark 500 is rectangular as illustrated in FIG. 5. As illustrated in FIG. 5, the intersection recognizing unit 301 recognizes two straight lines not parallel to each other among straight lines included in the register mark 500, for example, recognizes “straight lines to be recognized” illustrated in FIG. 5. Then, as illustrated in FIG. 5, the intersection recognizing unit 301 recognizes the intersection 600 formed by the recognized straight lines. A cover film end illustrated in FIG. 5 is an end of a cover film placed to prevent a short circuit between the register mark 500 and an adjacent wiring pattern. An outer shape end illustrated in FIG. 5 is an end of the FPC 403. FIG. 5 is a diagram for explaining the intersection recognizing unit 301 in the embodiment.

The connection aligning unit 302 is connected to the intersection recognizing unit 301, receives the intersection 600 recognized by the intersection recognizing unit 301, and determines a position to which the head terminal 401 is to be connected. For example, the connection aligning unit 302 stores in advance a relation between the position of the intersection 600 and the position to which the head terminal 401 is to be connected, and determines a position for connection based on the intersection 600 recognized by the intersection recognizing unit 301 and the relation.

The position determined by the connection aligning unit 302 is sent to, for example, the connecting device that connects the head terminal 401 and the FPC terminal 402, and is used by the connecting device to connect the head terminal 401 and the FPC terminal 402.

Examples of the relation between the position of the intersection 600 and the position to which the head terminal 401 is to be connected include the distance between the intersection 600 and the FPC terminal 402 and the distance between an end of the head terminal 401 superposed on the FPC 403 and the intersection 600.

Described below is the reason for using a pattern with a plurality of straight lines as the register mark 500.

The position on the FPC 403 where the FPC terminal 402 is formed may be significantly misaligned because of, for example, a step of laminating materials at the time of fabricating the FPC 403. As a result, the position of the register mark 500 formed according to the position of the FPC terminal 402 may also be misaligned due to the misalignment of the FPC terminal 402.

As illustrated in FIG. 6, when an upper portion of the register mark 500 is covered with a cover film, light diffusion occurs on the cover film. Accordingly, stable image recognition is not possible compared with the case without a cover film. Therefore, a cover film is not provided above the register mark 500. Since misalignment of the register mark 500 often occurs, a wide opening area is provided for the cover film not to cover the upper portion of the register mark 500 even if misalignment occurs.

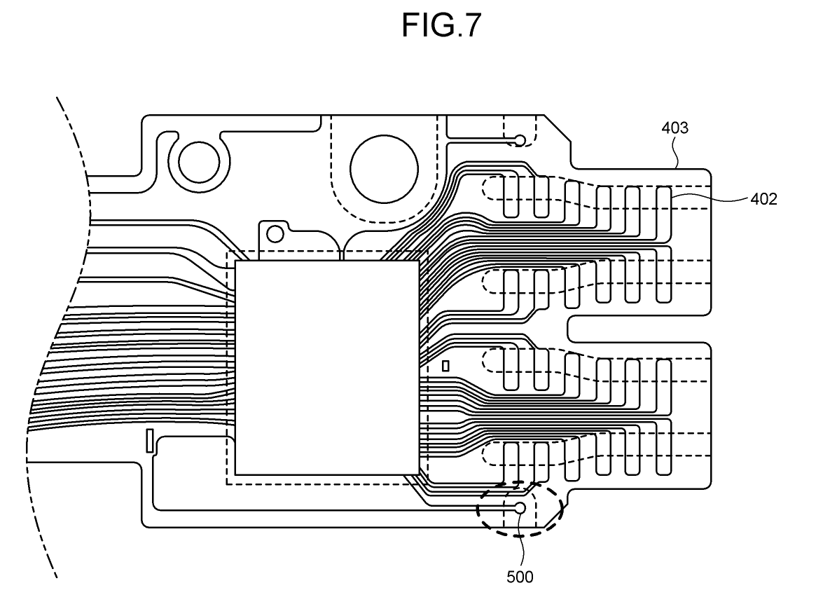

When the upper portion of the register mark 500 is not covered with a cover film, as indicated by a portion surrounded by a dotted line in FIG. 7, there is a case that the FPC terminal 402 is not entirely covered with a cover film. If the FPC terminal 402 not covered with a cover film and the register mark 500 are placed close together, a short circuit may occur in exposed circuits. To prevent this, the position of the register mark 500 is set closer to an outer end face.

FIG. 6 is a diagram for explaining a difference in light reflectance between the presence and absence of a cover film in the embodiment. FIG. 7 is a diagram for explaining exposure of an adjacent wiring pattern without a cover film in the embodiment.

That is, the register mark 500 is formed at a position near an end on the FPC 403, and also a large misalignment may occur. As a result, part of the register mark 500 may run over from the top of the FPC 403 and be lost. With this, the shape of the register mark 500 may be distorted, or part of the register mark 500 may superpose the cover film.

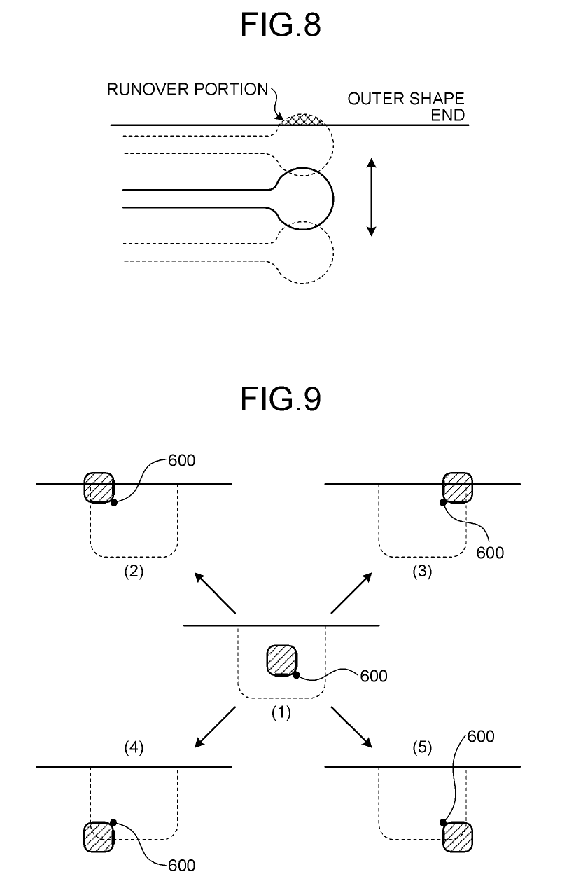

When a circular pattern is used as the register mark as in conventional technologies, if the circular shape is distorted, such distorted circular pattern cannot be used as the register mark. That is, for example, as illustrated in FIG. 8, when part of the circular pattern runs over the outer shape end of the FPC 403 and the shape is distorted due to misalignment or when part of the circular pattern superposes the cover film, the circular pattern cannot be used as the register mark. FIG. 8 is a diagram for explaining distortion of the shape of the register mark due to misalignment.

A distorted circular pattern cannot be used as the register mark because the aligning device determines a connecting position based on, for example, the center of the circular pattern, and cannot recognize the center if the circle shape is distorted.

According to the embodiment, a pattern with a plurality of straight lines is used as the register mark 500. Therefore, as long as two straight lines not parallel to each other can be recognized, the intersection 600 can be recognized, and therefore a connecting position can be determined. That is, a connecting position can be determined even when part of the register mark 500 is not formed on the FPC as indicated by (2) and (3) of FIG. 9 or when part of the register mark 500 is formed on a portion covered with the cover film as indicated by (4) and (5) of FIG. 9. FIG. 9 is a diagram for explaining intersection recognition when a register mark is rectangular.

The case is illustrated by (1) of FIG. 9 where the whole register mark 500 is formed on a portion of the FPC not covered with a cover film. In the case of (1) of FIG. 9, the intersection recognizing unit 301 recognizes arbitrary straight lines to recognize the intersection 600. In FIG. 9, bold lines represent straight lines recognized by the intersection recognizing unit 301.

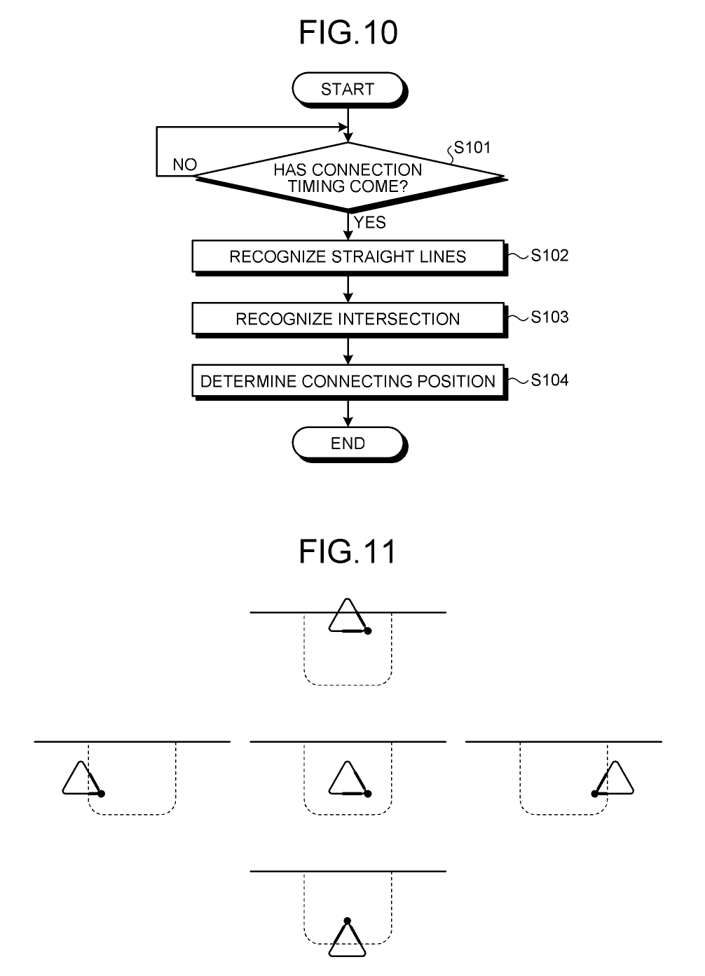

Next, the operation of the aligning device is explained with reference to FIG. 10. FIG. 10 is a flowchart of the operation of the aligning device in the embodiment.

As illustrated in FIG. 10, when connection timing comes (Yes at step S101), that is, when timing to connect the head terminal 401 and the FPC terminal 402 comes, the intersection recognizing unit 301 recognizes straight lines from the register mark 500 (step S102). That is, the intersection recognizing unit 301 recognizes two straight lines not parallel to each other from the register mark 500.

The intersection recognizing unit 301 then recognizes the intersection 600 of the straight lines (step S103). The connection aligning unit 302 then determines a connecting position based on the intersection 600 recognized by the intersection recognizing unit 301 (step S104). That is, the connection aligning unit 302 determines a connecting position where the head terminal 401 and the FPC terminal 402 are connected together.

As described above, according to the embodiment, a position can be stably determined. Specifically, even when part of the register mark runs over the top of the FPC and the shape of the register mark is distorted, a position can be stably determined as long as two straight lines not parallel to each other can be recognized.

Compared with conventional technologies using a circular register mark, according to the embodiment, a position can be determined with the small register mark 500. That is, displaying recognizable straight lines is easier than displaying recognizable arcs. The minimum size of the register mark 500 with recognizable straight lines is smaller than the minimum size of a circular shape with recognizable arcs. As a result, the register mark can be smaller compared with the conventional technologies using a circular register mark.

While a specific embodiment has been described, other embodiments or modifications are also possible. In the following, such embodiments are explained.

For example, in the embodiment, the register mark 500 is described as being rectangular. However, the shape of the register mark is not so limited. For example, if the register mark 500 is triangular as illustrated in FIG. 11, even if part of the register mark 500 is lost, an intersection can be recognized as long as two straight lines can be recognized. Thus, stable alignment can be achieved as in the case of using a rectangular register mark. FIG. 11 is a diagram for explaining intersection recognition when a register mark is triangular.

The process procedure, the control procedure, specific names, and information including various data and parameters described above and illustrated in the drawings (for example, FIGS. 2 to 5 and 9 to 11) can be arbitrarily changed unless otherwise specified.

The constituent elements described above are functionally conceptual, and need not be physically configured as illustrated. In other words, the specific mode of dispersion and integration of the constituent elements is not limited to the ones illustrated in the drawings, and the constituent elements, as a whole or in part, can be divided or integrated either functionally or physically based on various types of loads or use conditions. For example, in the example of FIG. 2, the image obtaining unit 101 may be provided separately from the aligning device 100.

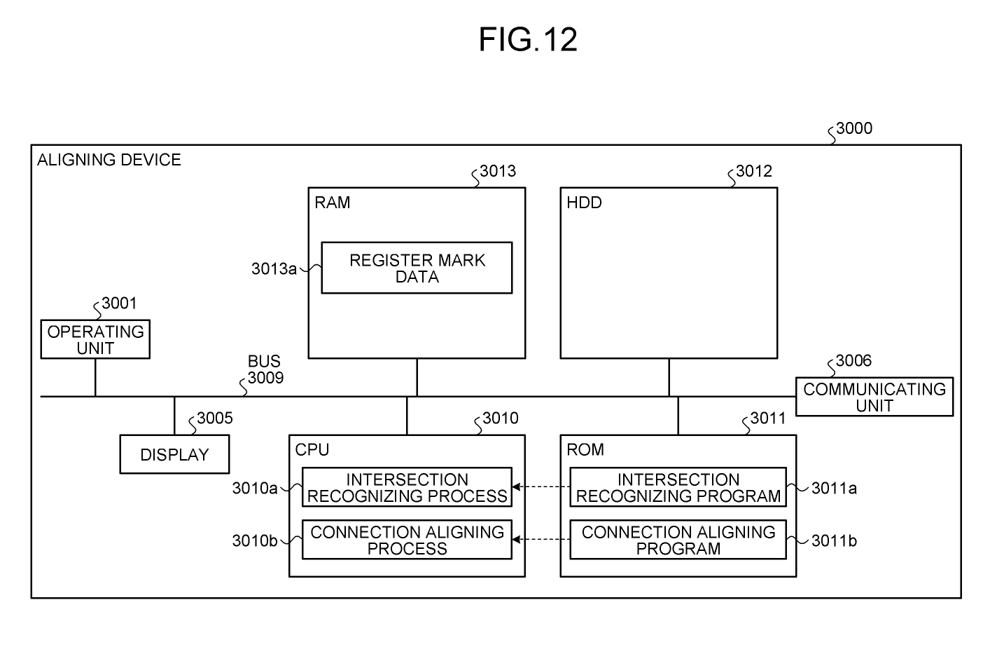

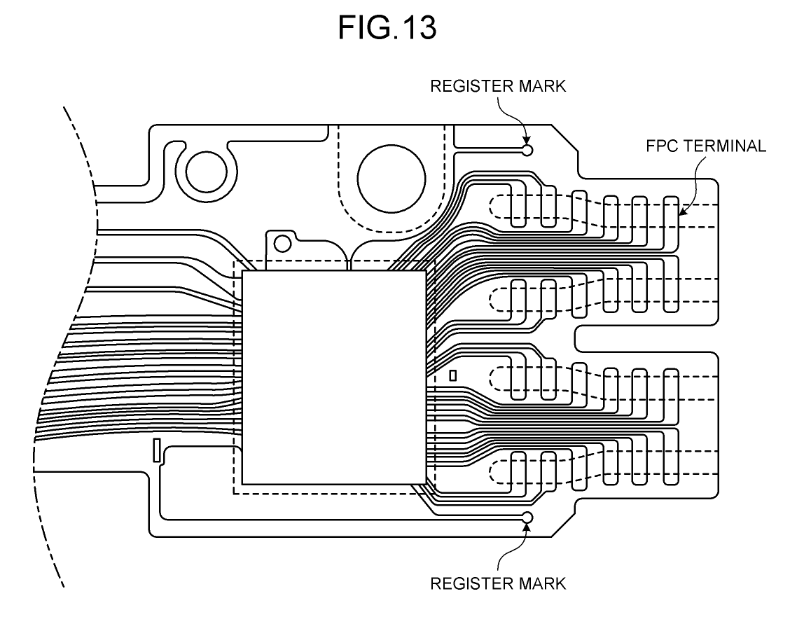

Further, various processes described above can be implemented by executing a program provided in advance on a computer such as a personal computer or a work station. That is, each process explained in the above embodiment can be implemented by a central processing unit (CPU), a micro controller unit (MCU), or a micro processing unit (MPU) executing a program provided in advance. In the following, an example of a computer that executes a computer program (hereinafter, “aligning program”) to implement the same function as the aligning device of the above embodiment is described with reference to FIG. 12. FIG. 12 is a diagram for explaining an aligning program that implements the aligning device according to the embodiment.

As illustrated in FIG. 12, an aligning device 3000 includes an operating unit 3001, a display 3005, a communicating unit 3006, a CPU 3010, a read-only memory (ROM) 3011, a hard disk drive (HDD) 3012, and a random access memory (RAM) 3013, which are connected via a bus 3009 or the like. Although not illustrated, the aligning device 3000 receives via the communicating unit 3006 an instruction for alignment from a connecting device that connects the head terminal 401 and the FPC terminal 402, and sends a connecting position to the connecting device.

The ROM 3011 stores in advance control programs, i.e., an intersection recognizing program 3011a and a connection aligning program 3011b as illustrated in FIG. 12, achieving the same function as the intersection recognizing unit 301 and the connection aligning unit 302 of the embodiment. The programs 3011a and 3011b may be integrated or separated, as with the constituent elements of the aligning device illustrated in FIG. 2.

When the CPU 3010 reads the programs 3011a and 3011b from the ROM 3011 and executes them, as illustrated in FIG. 12, the programs 3011a and 3011b implement an intersection recognizing process 3010a and a connection aligning process 3010b, respectively. The processes 3010a and 3010b correspond to the intersection recognizing unit 301 and the connection aligning unit 302 illustrated in FIG. 2. The CPU 3010 then executes the aligning program using register mark data 3013a.

As described above, the aligning device described above can be implemented by executing the aligning program provided in advance on a computer such as a personal computer or a work station. The program can be distributed via a network, such as the Internet. The program can also be stored in a computer-readable storage medium, such as hard disk, flexible disk (FD) , compact-disk read only memory (CD-ROM), magneto-optical disk (MO) , and digital versatile disk (DVD) , and read by the computer therefrom to be executed.

The aligning device can be applied not only to a magnetic disk device but also similarly applied to a storage device such as an optical disk device.

As described above, according to the embodiment, a position can be stably determined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. An aligning device comprising:
a recognizing unit that recognizes an intersection formed by two straight lines not parallel to each other among a plurality of straight lines included in a register mark; and
a determining unit that determines a position based on the intersection recognized by the recognizing unit.

2. The aligning device according to claim 1, wherein
the register mark is used when a flexible printed circuit terminal and a head terminal are superposed and connected, the flexible printed circuit terminal being a wiring pattern formed on a flexible printed circuit in a storage device, and the head terminal being one of wiring patterns that are connected to a head in the storage device and being located in a portion that is superposed with the flexible printed circuit terminal, and
the determining unit determines a position on the flexible printed circuit where the head terminal is superposed.

3. An aligning method comprising:
recognizing an intersection formed by two straight lines not parallel to each other among a plurality of straight lines included in a register mark; and
determining a position based on the intersection recognized by the recognizing unit.

4. A computer readable storage medium comprising code that, when executed, causes a computer to perform:
recognizing an intersection formed by two straight lines not parallel to each other among a plurality of straight lines included in a register mark; and
determining a position based on the intersection recognized by the recognizing unit.

5. A method of fabricating a storage device, the method comprising:
recognizing an intersection formed by two straight lines not parallel to each other among a plurality of straight lines included in a register mark used when a flexible printed circuit terminal and a head terminal are superposed and connected, the flexible printed circuit terminal being a wiring pattern formed on a flexible printed circuit in the storage device, and the head terminal being one of wiring patterns that are connected to a head in the storage device and being located in a portion that is superposed with the flexible printed circuit terminal; and
determining a position on the flexible printed circuit where the head terminal is superposed based on the intersection recognized at the recognizing.
